(19) United States
(12) Patent Application Publication
(10) Pub. No.: US 2026/0354937 A1
(43) Pub. Date: Nov. 12, 2026

(54) TESTING APPARATUS FOR POLYMERIC DENTAL ALIGNER

(71) Applicant: Solventum Intellectual Properties Company, Maplewood, MN (US)

(72) Inventors: Barry S. DENSCH, Minneapolis, MN (US); Karl J.L. GEISLER, Saint Paul, MN (US); Bruce R. BROYLES, Oakdale, MN (US); Ta-Hua YU, Woodbury, MN (US); Glendon D. KAPPEL, Eagan, MN (US)

(21) Appl. No.: 19/123,299

(22) PCT Filed: Nov. 6, 2023
(86) PCT No.: PCT/IB2023/061183

§ 371 Date: Apr. 22, 2025

Related U.S. Application Data
(60) Provisional application No. 63/431,385, filed on Dec. 9, 2022.

(51) Int. Cl. A61C 7/08

(52) U.S. Cl. CPC A61C 7/08

(57) ABSTRACT

A testing apparatus for a polymeric dental aligner includes an arch platform positioned between and movably coupled to both an ejector platform and a seating platform. An arch model is coupled to the arch platform and configured to receive an aligner for testing. A platform drive assembly is configured to move the platforms relative to one another in a repeatable motion to perform multiple testing cycles of seating and ejecting the aligner from the arch model.

The present disclosure relates to a testing apparatus and, in particular, to a testing apparatus for a polymeric dental aligner.

Orthodontics is a specialized area of dentistry concerned with the diagnosis and treatment of dental malocclusions to improve bite function, hygiene, and facial aesthetics. Orthodontic therapy commonly uses dental aligners, which may also be referred to as trays, alignment shells, or polymeric appliances, which are formed from a resilient polymeric material. Aligners are provided in a series and are intended to be worn in succession in order to gradually move the teeth in incremental steps toward a desired target arrangement. Some types of polymeric appliances have a row of tooth-shaped receptacles for receiving each tooth of the patient's dental arch, and the receptacles are oriented in slightly different positions from one appliance to the next in order to incrementally urge each tooth toward its desired target position by virtue of the resilient properties of the polymeric material. During treatment, the aligner is removably attached over a patient's dental arch. The patient may insert and remove the aligner multiple times per day.

### SUMMARY

The present disclosure provides a testing apparatus, which may be used to evaluate the durability of an aligner, which may be used to inform the selection of an appropriate material and process to make aligners or inform the design of the aligner for particular malocclusions or other dental arch features. In particular, the present disclosure provides a testing apparatus configured to facilitate repeated insertion and removal cycles of the aligner on an arch model.

In one aspect, the present disclosure provides a testing apparatus for a polymeric dental aligner, including: an ejector platform; a seating platform coupled to the ejector platform; an arch platform positioned between and movably coupled to both the ejector platform and the seating platform; an arch model coupled to the arch platform and configured to receive the aligner for testing; and a platform drive assembly coupled to one or more of the ejector platform, the seating platform, and the arch platform and configured to move the platforms relative to one another in a repeatable motion to perform a testing cycle including moving to seat the aligner onto the arch model and moving the arch model to eject the aligner from the arch model.

A testing method for an aligner, including: seating an aligner onto the arch model of a testing apparatus according to the present disclosure; operating the testing apparatus to perform one or more testing cycles on the aligner; and determining whether the aligner has failed after the one or more testing cycles.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view of a testing apparatus in accordance with one embodiment.

FIGS. 2A-B each illustrate a different perspective view of various components of the testing apparatus of FIG. 1 and an aligner in accordance with one embodiment.

FIG. 3 illustrates a cross-sectional view of a component of the testing apparatus of FIG. 1.

FIG. 4 illustrates a side elevation view of the testing apparatus of FIG. 1 in a first position.

FIG. 5 illustrates a side elevation view of the testing apparatus of FIG. 1 in a second position.

FIG. 6 illustrates a side elevation view of the testing apparatus of FIG. 1 in a third position.

FIG. 7 illustrates a diagram of a method of using the testing apparatus of FIG. 1 in accordance with one embodiment.

### DETAILED DESCRIPTION

As used herein, terms related to orientation or direction, such as “upward,” “downward,” “higher,” “lower,” “anterior,” “posterior,” “superior,” “inferior,” “lateral,” among others, are used to describe relative positions of components and are not meant to limit the absolute orientation of the embodiments contemplated.

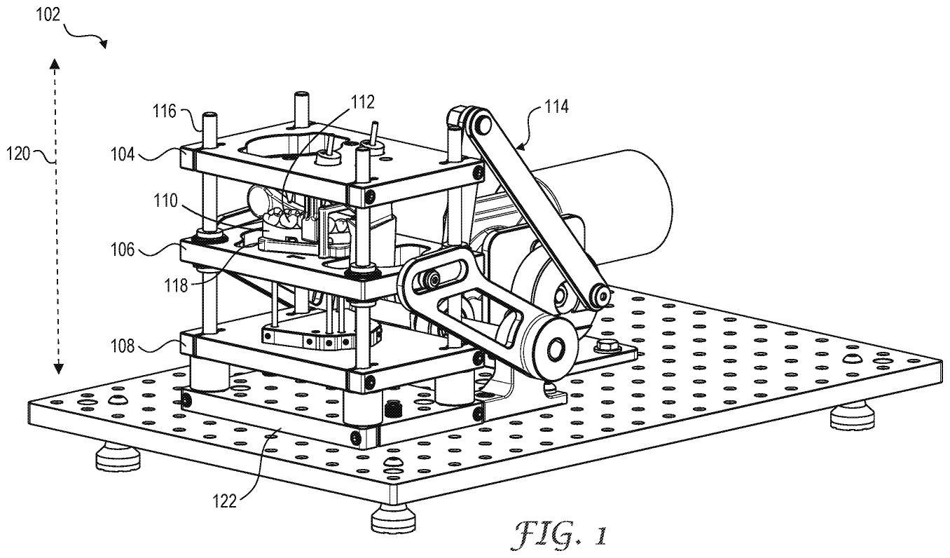

FIG. 1 shows a perspective view of one example of a testing apparatus 102 according to the present disclosure. The testing apparatus 102 may be used to evaluate the durability of an aligner 112, which may be used to inform the selection of an appropriate material and process to make the aligner or inform the design of the aligner for particular malocclusions or other dental arch features. In particular, testing apparatus 102 is configured to facilitate repeated insertion and removal cycles of the aligner 112 on an arch model 110.

The testing apparatus 102 advantageously facilitates consistent simulation of the effects of a user inserting and removing on an aligner. Once the aligner 112 is inserted into the testing apparatus 102, various components are arranged to eject and seat the aligner 112 while keeping the aligner constrained in translation and orientation. Ejecting the aligner 112 from the arch model 110 is generally configured to stimulate removal of the aligner from the dental arch of a patient. Seating, or reseating, the aligner 112 on the arch model 110 is generally configured to simulate the insertion of the aligner 112 onto the dental arch of a patient. The aligner 112 may be cycled numerous times, such as 10, 25, 50, 100, 250, 500, or more times to test the durability of the aligner. Once cycled, the aligner 112 may be inspected for failures, such as cracks, plastic deformation, or haze visible in the aligner material. Such results may be used to select materials or processes to make the aligner 112 that are suitable according to any manufacturing means, such as additive or subtractive manufacturing techniques or thermoforming. For example, different types of aligners may be designed to correct one or more malocclusions, such as proclined teeth, an asymmetric dental arch, or crowded teeth. When cycling a certain number of times does not lead to a failure, a certain material may be deemed as suitable for the type of aligner. Alternatively, or additionally, the aligner may be redesigned for more resilient based on analysis of any failures detected.

In some embodiments, various components of the testing apparatus 102 are formed of generally rigid or semi-rigid materials, such as metal or plastic or other polymeric material, that are more durable than the aligner 112. Such materials may facilitate accurate simulation and repeatable cycling.

The testing apparatus 102 for the polymeric dental aligner 112 includes multiple platforms. In general, each platform provides mechanical support to various other components of the testing apparatus 102 acting on the aligner 112. In the illustrated embodiment, the testing apparatus 102 includes an ejector platform 108, a seating platform 104 coupled to the ejector platform, and an arch platform 106 positioned between and movably coupled to both the ejector platform and the seating platform. The ejector platform 108 and the seating platform 104 may be separated by a fixed distance. The arch platform 106 is configured to translate linearly between the ejector platform 108 or the seating platform 104 along a vertical axis 120. An oscillation of the arch platform 106 along the vertical axis 120 corresponds to one cycle of ejecting and seating the aligner 112. Although each platform may have any suitable shape, each platform may have a generally rectangular prism shape, as in the illustration.

The platforms are coupled together in any suitable manner. For example, the testing apparatus 112 may include one or more platform guides 116 coupled to one or more of the ejector platform 108, the seating platform 104, and the arch platform 106. As illustrated, the testing apparatus 102 includes multiple platform guides 116, four of them, coupled to each of the platforms proximate to the corners of each platform. In particular, the platform guides 116 are fixedly coupled to the ejector platform 108 and the seating platform 104 and movably coupled to the arch platform 106, which allows the arch platform 106 to translate between the other platforms. The platform guides 116 may have any suitable shape, such as a cylindrical rod, as in the illustration.

The testing apparatus 102 may be coupled to a base 122 to mechanically fix the testing apparatus in a secure position. One or more of the platforms may move relative to the base 122. In the illustrated embodiment, the ejector platform 108 and the seating platform 104 are fixed relative to the base 122 and the arch platform 106 is movable relative to the base along the platform guides 116. In other embodiments (not shown), the ejector platform 108 and the seating platform 104 is movable relative to the base 122 and the arch platform 106 is fixed relative to the base.

The testing apparatus 102 includes an arch model 110 configured to receive the aligner 112 for testing. The arch model 110 may be described as being coupled to, or included in, the arch platform 106. The aligner 112 is ejected from the arch model 110 and seated onto the arch model 110 to complete one testing cycle. The arch model 110 is a representation of a dental arch, which may be artificially designed or may be a model of a patient's dental arch. The arch model 110 is coupled to the arch platform 106.

The testing apparatus 102 further includes a platform drive assembly 114 configured to move the platforms relative to one another in a repeatable motion to perform a testing cycle including moving to seat the aligner 112 onto the arch model 110 and moving the arch model to eject the aligner from the arch model. The platform drive assembly 114 is coupled to one or more of the platforms. In the illustrated embodiment, the platform drive assembly 114 is coupled to the arch platform 106 and configured to move the arch platform 106 relative to the ejector platform 108 and the seating platform 104, as well as the base 122. In other embodiments (not shown), the platform drive assembly 114 is coupled to the ejector platform 108 and the seating platform 104 to move them relative to the arch platform 106 and the base 122.

The platform drive assembly 114 may include any suitable mechanisms capable of translating or otherwise moving the arch platform 106 relative to the other platforms and powering such movement. For example, the platform drive assembly 114 may include a powered motor or manual user interface to power relative movement of the arch platform 106 relative to the other platforms.

In the illustrated embodiment, the platform drive assembly 114 includes a powered motor. The motor is coupled to a four-bar linkage, which includes a crank wheel and cam arms coupled to the crank wheel. The cam arm of the platform drive assembly 114 engages with a protrusion (e.g., roller bearing) of the arch platform 106 to apply a force to move the arch platform 106 along the platform guides 116.

In other embodiments (not shown), additionally or alternatively, the platform drive assembly 114 includes a manual user interface. The manual user interface may include any suitable mechanism, such as a handle to provide a rotary motion and cam arms coupled to the handle.

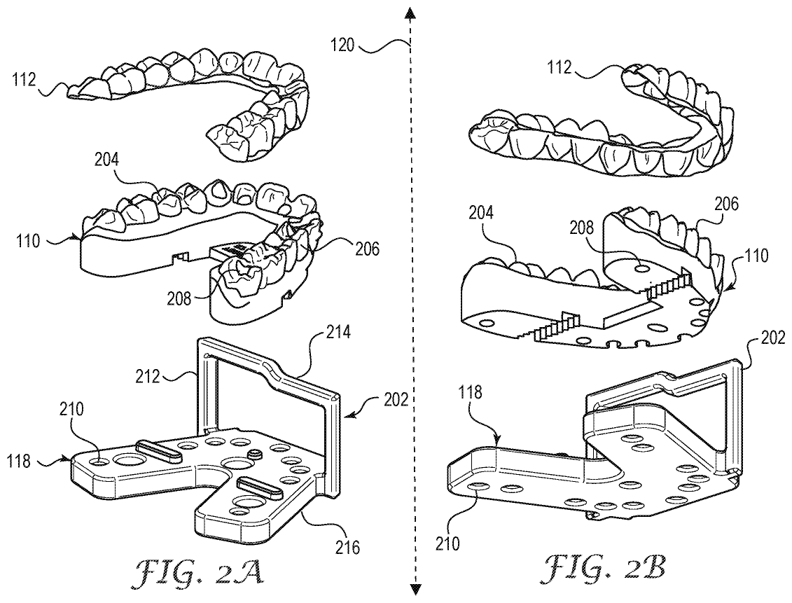

FIGS. 2A-B show different perspective views of various components of the testing apparatus 102 and the aligner 112. In particular, the aligner 112 is shown separated from the arch model 110.

The arch model 110 may include various features to represent a dental arch. As illustrated, the arch model 110 includes multiple shapes representing the contours, orientations, and locations of various teeth in a dental arch. The arch model 110 may include various test features selected to present various challenges to the durability of the aligner 112.

As used herein, with respect to the arch model 110 or the aligner 112, malocclusions, teeth, or other dental terms refer to features of the arch model 110 intended to represent a dental arch or features of the aligner 112 configured to engage with corresponding features of a dental arch. Features representing malocclusions may be described as malocclusion test features. In some embodiments, the arch model 110 includes at least one malocclusion test feature.

A malocclusion may include one or more proclined teeth. The arch model 110 may define an occlusal plane. As used herein, the term “occlusal plane” refers to the commonly accepted use of the term to one skilled in the art or, alternatively, to a plane parallel to a major bottom surface of an arch model, which may be orthogonal to the vertical axis 120 when the arch model 110 is installed in the test testing apparatus 102. In some embodiments, a malocclusion test feature includes at least one incisor proclined at least 10 degrees from orthogonal to the occlusal plane.

Another malocclusion may include an asymmetric dental arch. The arch model 110 may define an occlusal plane, a first hemiarch 204, and a second hemiarch 206. In some embodiments, a malocclusion test feature includes the first hemiarch 204 having at least one tooth having a first cusp tip distance from the occlusal plane at least 0.5, 1, 1.5, 2, 3, 4, or even 5 millimeters (mm) different than a second cusp tip distance from the occlusal plane of at least one corresponding tooth of the second hemiarch. For example, one molar in a left hemiarch may be higher than the corresponding molar in the right hemiarch.

Yet another malocclusion may include crowded teeth. In particular, in some embodiments, a malocclusion test feature includes at least one region of crowded teeth.

The arch model 110 may also represent non-anatomical, or artificial, structures attached to a dental arch. Features representing a non-anatomical structure may be described as a non-anatomical test features. In some embodiments, the arch model 110 includes at least one non-anatomical test feature, such as an aligner attachment test feature. An aligner attachment is bonded to a tooth of a dental arch, which facilitates providing additional surface area and leverage to facilitate movement teeth and may also facilitate removable attachment of the aligner 112 to the dental arch.

Various other test features may be included in the arch model 110 by one skilled in the art having the benefit of the present disclosure.

The arch model 110 may be made of any suitable rigid or semi-rigid material. In some embodiments, the arch model 110 is made of at least a polymeric material, which may be formed by any suitable additive or subtractive manufacturing technique, such as 3D printing.

The arch platform 106 of the testing apparatus 102 (FIG. 1) may include a model fixture 118 to couple the arch model 110 to the arch platform 106 (FIG. 1). Both the model fixture 118 and the arch model 110 may include various features to attach to one another. In general, a first surface of the arch model 110 is configured to engage and attach to the aligner 112 and a second surface opposite the first surface is configured to engage and attach to the model fixture 118. In some embodiments, the arch model 110 is removably coupled to the arch platform 106. In some embodiments, the arch model 110 includes, or is couplable to, a clamp (FIG. 1) to facilitate manual removal of the arch model 110 from the arch platform 106 and the model fixture 118.

The arch platform 106 of the testing apparatus 102 may also include a capture frame 202 positioned to restrict movement of the aligner 112 after ejection from the arch model 110, for example, restricting movement at least partially in the anterior and one or more lateral directions. The capture frame 202 may be configured to engage at least one anterior or lateral portion, or surface, of the aligner 112. In the illustrated embodiment, the capture frame 202 is positioned to engage the canine or premolar portions of the aligner 112.

The capture frame 202 may have any suitable shape to accommodate the shape of the aligner 112. In the illustrated embodiment, the capture frame 202 includes two side elements 212 and a cross element 214 to form a loop with a base element 216 of the model fixture 118. The cross element 214 includes at least one bend, for example, to facilitate the contours of the arch model 110 representing a malocclusion including an asymmetric dental arch. In other embodiments (not shown), the cross bar may have a straight or other non-linear shape.

In the illustrated embodiment, the capture frame 202 is integrally formed from a single piece of material with the model fixture 118 and may be described as being part of the model fixture 118. In other embodiments (not shown), the capture frame 202 may be formed from a separate piece of material coupled to the model fixture 118.

The capture frame 202 and the arch model fixture 118 may be made of any suitable rigid or semi-rigid material, such as a metal or polymeric material. In some embodiments, the capture frame 202 is formed of a metal or polymeric material and the model fixture 118 is also formed of a metal or polymeric material.

The arch model 110 may include one or more first apertures 208 extending through from a first surface to a second opposite surface to facilitate ejection of the aligner 112. The first apertures 208 may extend along the vertical axis 120 (see also FIG. 1). In the illustrated embodiment, the arch model 110 includes multiple first apertures 208, two proximate to the molars and five proximate to the incisors and canines of the arch model 110.

The model fixture 118 may also include one or more second apertures 210 extending through from a first surface to a second opposite surface to facilitate ejection of the aligner 112. The apertures 208 may extend along the vertical axis 120 and may be aligned to the first apertures 208 of the arch model 110. In the illustrated embodiment, the model fixture 118 includes multiple second apertures 210, two proximate to the molars and five proximate to the incisors and canines of the arch model 110.

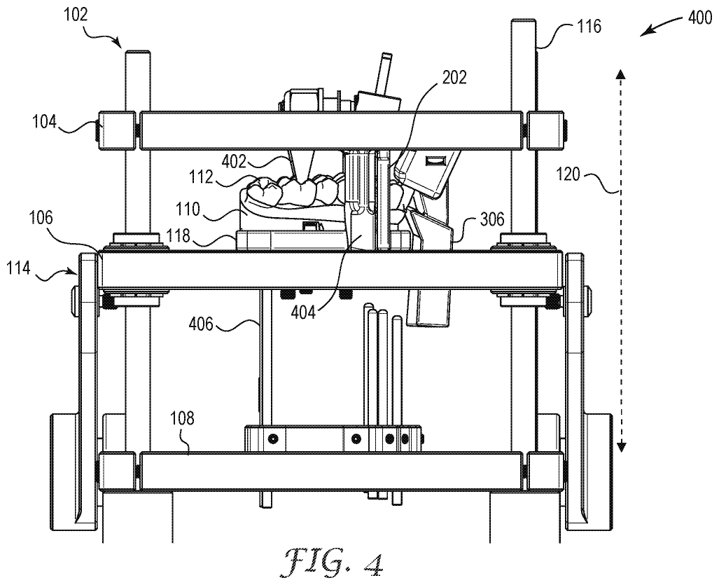

The first apertures 208 and second apertures 210 may facilitate ejection of the aligner 112 from the arch model 110 by allowing ejector elements 406 (FIG. 4) to pass through to engage and lift the aligner 112.

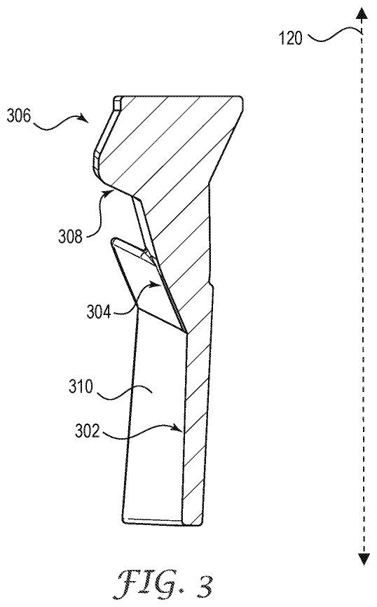

FIG. 3 a cross-sectional view of an anterior guide 306 of the seating platform 104 of the testing apparatus 102 (FIG. 1). The anterior guide 306 is positioned to engage an anterior portion, or surface, of the aligner 112. The anterior guide 306 includes one or more surfaces configured to facilitate guiding the aligner 112 toward alignment with the arch model 110 during seating and restricting aligner movement in the anterior direction when ejecting. In the illustrated embodiment, the anterior guide 306 includes at least a first surface 302, a second surface 304, and a third surface 308. Each surface may have a different angle to encourage different movements of the aligner 112 (FIG. 1) at different stages of seating. The first surface 302 is parallel or almost parallel (e.g., a small angle) relative to the vertical axis 120 (see also FIG. 1), which may restrict movement of the aligner in the anterior direction after ejection. The second surface 304 has a greater angle relative to the vertical axis 120 than the first surface 302, which may encourage the aligner 112 in a posterior and inferior direction during the seating process. The third surface 308 has an even greater angle relative to the vertical axis 120 than the second surface 304, which may encourage the aligner 112 in mainly inferior direction, and also a posterior direction, near the end of the seating process.

The anterior guide 306 may also include other surfaces to facilitate alignment of the aligner 112 in lateral directions. For example, as illustrated, the anterior guide 306 includes a fourth surface 310 having an inward angle toward the lateral center of the anterior guide 306. Such inward angled surface may be used to provide a generally concave posterior major surface of the anterior guide 306, which may restrict lateral movement of the aligner 112, particularly during the seating process.

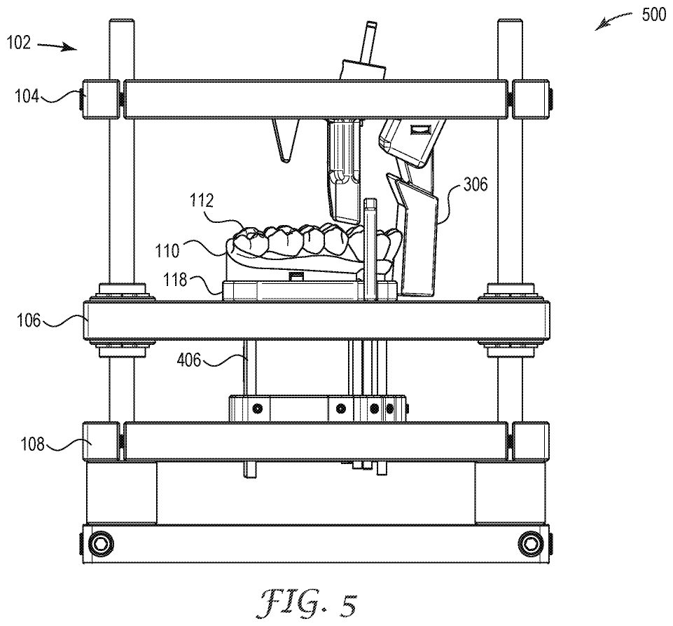

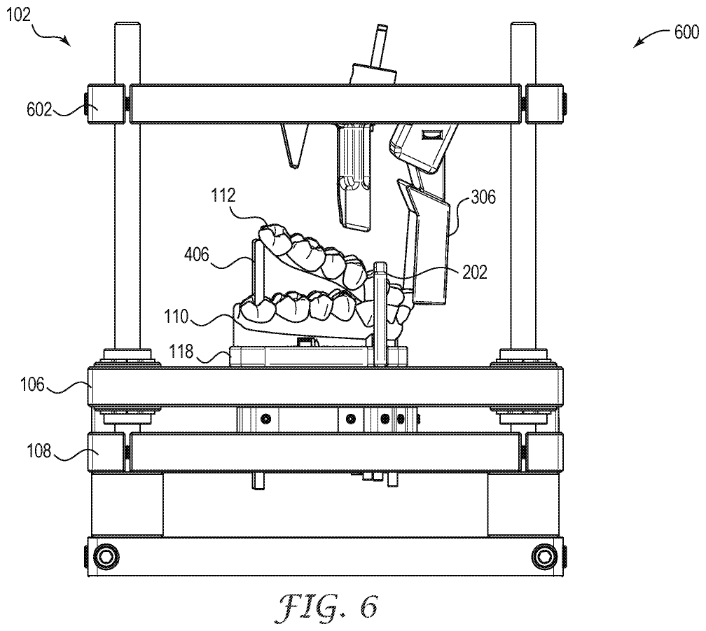

FIGS. 4-6 show various positions of the testing apparatus 102 used to perform a testing cycle including ejection and seating of the aligner 112. In general, the testing apparatus 102 will oscillate between a seated position and an ejected position. FIG. 4 shows a side elevation view of the testing apparatus 102 in a first position 400, which may also be described as a seated position. FIG. 6 shows a side elevation view of the testing apparatus 102 in a third position 600, which may also be described as an ejected position. FIG. 5 shows a side elevation view of the testing apparatus 102 in a second position 500, which is between the first and third positions and may also be described as an ejecting position or seating position depending on the current direction of movement of the arch platform 106.

In one example of using the testing apparatus 102, the testing apparatus may start at the second position 500 to manually attach the aligner 112 onto the arch platform 106 to load the aligner into the testing apparatus 102 for testing. The testing apparatus 102 may then be powered to move toward either the first position 400 or the third position 600. In this example, the testing apparatus 102 will move toward the third position 600 to eject the aligner 112 from the arch model 110. Next, in the cycle, the testing apparatus 102 will move back toward the second position 500. Then, the testing apparatus 102 will move toward the first position 400 to seat the aligner 112 onto the arch model 110. Finally, the testing apparatus 102 will move back to the second position 500 to complete one testing cycle in this example.

The testing apparatus 102 may include various components to facilitate ejection and seating of the aligner 112. For ejecting, the ejector platform 108 of the testing apparatus 102 may be coupled to or include one or more ejector elements 406. The ejector elements 406 may extend along the vertical axis 120 (see also FIG. 1) and may be aligned to the first apertures 208 of the arch model 110 and the second apertures 210 of the model fixture 118 (FIG. 2A and FIG. 2B). In particular, each ejector element 406 may be configured to extend through one first aperture 208 and one second aperture 210.

In the illustrated embodiment, the ejector platform 108 includes multiple ejector elements 406, two proximate to the molars (posterior ejector elements) and five proximate to the incisors and canines (anterior ejector elements) of the arch model 110 when the ejector elements 406 extend through the first apertures 208 and second apertures 210.

The ejector elements 406 may have different heights as measured from a plane of the ejector platform 108 or from the occlusal plane of the arch model 110. In some embodiments, the ejector elements 406 proximate to the incisors have a height less than the ejector elements proximate to the molars, which is intended to simulate the typical natural motion of a patient removing the aligner 112 from a dental arch. The average difference in height between the anterior and posterior ejector elements 406 may be, for example, at least 0.5, 1, 1.5, 2, or even 2.5 centimeters (cm).

Each ejector element 406 may have a height calibrated to the shape of the aligner 112. In some embodiments, the posterior ejector elements 406 may each have an individual height configured to engage the aligner 112 at the same time as other posterior ejector elements 406 during the ejecting process. The anterior ejector elements 406 may each have an individual height configured to engage the aligner 112 at the same time as other anterior ejector elements 406 during the ejecting process. In this respect, each of the posterior ejector elements 406 may have the same or different height, and each of the anterior ejector elements 406 may have the same or different height.

The ejector element 406 may be made of any suitable rigid or semi-rigid material, such as a metal or polymeric material. In some embodiments, the ejector element 406 is formed of a metal rod with a rounded tip to engage the aligner 112.

In the testing cycle example described herein above, at the start, the ejector elements 406 are positioned to engage a bottom surface of the aligner 112, which is the same surface of the aligner 112 that engages the arch model 110, through the first apertures 208 and the second apertures 210 in the second position 500. As the testing apparatus 102 moves toward the third position 600, the ejector elements 406 apply an upward force onto the aligner 112 as the arch platform 106 moves downward toward the ejector platform 108. In the third position 600, the aligner 112 is lifted and ejected from the arch model 110 due to the forces applied by the ejector elements 406. Due at least partly to the height differential between the posterior and anterior ejector elements 406, the aligner 112 tilts forward such that the posterior portion of the aligner is higher than the anterior portion of the aligner.

Once ejected, the aligner 112 is no longer completely secured by the arch model 110, and The aligner 112 may be encouraged to move in the anterior direction due to the height differential of the ejector elements 406. The degrees of freedom of the aligner 112 may be restricted by one or more other components of the testing apparatus 102. In particular, the testing apparatus 102 is configured to restrict movement of the aligner 112 in lateral directions, roll directions, and yaw directions throughout the testing cycle. During the ejecting process, the testing apparatus 102 is configured to allow limited movement of the aligner 112 in the superior direction and forward pitch direction.

In some embodiments, an anterior portion of the aligner 112 may engage the capture frame 202. In general, the capture frame 202 is positioned to restrict movement of the aligner 112 after the arch model 110 is moved into the second position 500 and the aligner 112 is ejected from the arch model. In particular, one or both hemiarches of the aligner 112 may engage one or both side elements 212 of the capture frame 202 (see FIG. 2A and FIG. 2B) to restrict movement of the aligner during the ejecting process. One or both hemiarches of the aligner 112 may also engage the cross element 214 of the capture frame 202 (see FIG. 2A and FIG. 2B) to restrict movement of the aligner during the ejecting process.

In some embodiments, the aligner 112 may engage the anterior guide 306 of the seating platform 104. The anterior guide 306 may be described as being coupled to, or included in, the seating platform 104. The anterior guide 306 may extend generally in a downward direction from the seating platform 104. An anterior portion of aligner 112 may engage the first surface 302 or other surfaces, such as the fourth surface 310, of the anterior guide 306 to restrict movement of the aligner 112 during the ejecting process.

After ejecting, the testing apparatus 102 moves back toward the second position 500. As the ejector elements 406 retract from the arch platform 106 as the arch platform moves away from the ejector platform 108, the aligner 112 is allowed to return to a non-tilted position. Due to the restricted movement of the aligner 112 by the various components of the testing apparatus 102, the aligner rests on the arch model 110, while being not fully engaged or seated on the arch model, in the second position 500. For example, the aligner 112 may rest slightly higher on the arch model 110 than as illustrated in FIG. 5.

The testing cycle then continues with the testing apparatus 102 moving toward the first position 400 to align and fully seat the aligner 112 onto the arch model 110. The testing apparatus 102 includes various components, which engage various portions of the aligner 112, to adjust the position of the aligner and further facilitate seating.

The anterior guide 306 is positioned to engage the an anterior portion of the aligner 112 to guide the aligner toward alignment with the arch model 110 when the arch model is moved toward the first position 400 (or the seated position). In the illustrated embodiment, the anterior guide 306 is configured to engage an incisor portion or other anterior portion of the aligner 112. The anterior portion of the aligner 112 may engage, in sequence, the first surface 302, the second surface 304, and then the third surface 308. First, the first surface 302 may limit the aligner 112 from moving in an anterior direction. Then, the second surface 304 may encourage the aligner 112 to move in a posterior and inferior direction. Finally, the third surface 308 may encourage the aligner 112 to move mainly in an inferior direction, and also a posterior direction, to encourage the aligner 112 to become fully seated with the arch model 110.

The testing apparatus 102 may include one or more lateral guides 404 positioned to engage a lateral portion, or surface, of the aligner 112 to guide the aligner toward alignment with the arch model 110 when the arch model is moved toward the first position 400 (or the seated position). The lateral guides 404 may be described as being coupled to, or included in, the seating platform 104. The lateral guides 404 may extend generally in a downward direction from the seating platform 104.

In the illustrated embodiment, the testing apparatus 102 includes two lateral guides 404, each configured to engage a different lateral portion of the aligner. In the illustrated embodiment, the lateral guides 404 are positioned to engage the premolar portions of the aligner 112.

In some embodiments, each lateral guide 404 includes an angled surface configured to encourage the aligner 112 toward a central position in lateral alignment with the arch model 110 as the arch model 110 is moved toward the seated position. The angled surface may be positioned to engage the aligner 112 concurrent with the first surface 302 or second surface 304 of the anterior guide 306 engaging an anterior portion of the aligner. A vertical surface of the lateral guide 404 may be positioned to restrict lateral movement of the aligner 112 after passing by the angled surface. The vertical surface may be positioned to engage the aligner 112 concurrent with the second surface 304 or third surface 308 of the anterior guide 306 engaging an anterior portion of the aligner.

The lateral guides 404 may be made of any suitable rigid or semi-rigid material. In some embodiments, the lateral guides 404 are formed of a metal or polymeric material.

The testing apparatus 102 may include at least one seating driver 402 positioned to engage the aligner 112 to seat the aligner onto the arch model 110 when the arch model is moved toward the first position 400 (or the seated position). In the illustrated embodiment, two seating drivers 402 are configured to engage the molar portions of the aligner 112. The seating drivers 402 may encourage the aligner 112 in a posterior direction to become fully seated with the arch model 110.

The seating drivers 402 may be made of any suitable rigid or semi-rigid material, such as a metal or polymeric material. In some embodiments, the seating drivers 402 are formed of a metal having a rounded tip to engage the aligner 112.

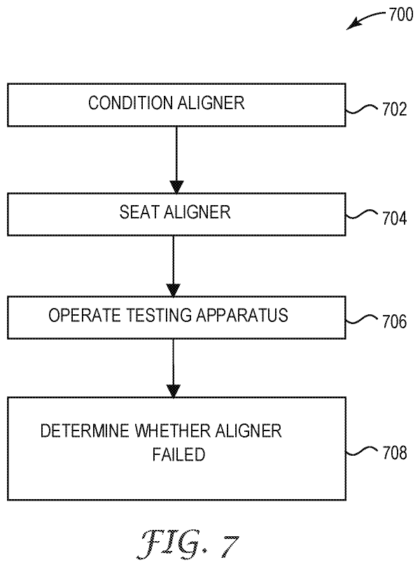

FIG. 7 shows a diagram of a method 700 of using the testing apparatus 102 in accordance with one embodiment. The method 700 may include conditioning the aligner in block 702. Conditioning the aligner may include soaking the aligner, optionally on a removable arch model, in a liquid before operating the testing test apparatus.

The method 700 may include seating the aligner onto the arch model on the testing apparatus in block 702. If the arch model was soaked on the arch model, the arch model with the aligner may be coupled to the arch platform.

The method 700 may include operating the testing apparatus to perform one or more testing cycles on the aligner.

The method 700 may include determining whether the aligner has failed after the one or more testing cycles. The material or design of the aligner may be altered in response to detecting a failure.

Thus, various embodiments of a testing apparatus for polymeric dental aligner are disclosed. Other features and combinations of features within the scope of this disclosure may be readily apparent to one skilled in the art from the figures, descriptions, and claims.

The terms “coupled” or “connected” refer to elements being attached to each other either directly (in direct contact with each other) or indirectly (having one or more elements between and attaching the two elements). Either term may be replaced to “couplable” or “connectable” to describe that the elements are configured to be coupled or connected.

As used herein, the term “configured to” may be used interchangeably with the terms “adapted to” or “structured to” unless the content of this disclosure clearly dictates otherwise.

Unless otherwise indicated, all numbers expressing feature sizes, amounts, and physical properties used in the specification and claims may be understood as being modified either by the term “exactly” or “about.” The singular forms “a,” “an,” and “the” encompass embodiments having plural referents unless its context clearly dictates otherwise.

The term “or” is generally employed in its inclusive sense, for example, to mean “and/or” unless the context clearly dictates otherwise. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A testing apparatus for a polymeric dental aligner, comprising:
an ejector platform;
a seating platform coupled to the ejector platform;
an arch platform positioned between and movably coupled to both the ejector platform and the seating platform;
an arch model coupled to the arch platform and configured to receive the aligner for testing; and
a platform drive assembly coupled to one or more of the ejector platform, the seating platform, and the arch platform and configured to move the platforms relative to one another in a repeatable motion to perform a testing cycle including moving to seat the aligner onto the arch model and moving the arch model to eject the aligner from the arch model.

2. The testing apparatus of claim 1, wherein the arch model includes at least one malocclusion test feature.

3. The testing apparatus of claim 2, wherein the arch model defines an occlusal plane and the malocclusion test feature includes at least one incisor proclined at least 10 degrees from orthogonal to the occlusal plane.

4. The testing apparatus of claim 2 wherein the arch model defines an occlusal plane, a first hemiarch, and a second hemiarch, wherein the malocclusion test feature includes the first hemiarch having at least one tooth having a first cusp tip distance from the occlusal plane at least 0.5 mm different than a second cusp tip distance from the occlusal plane of at least one corresponding tooth of the second hemiarch.

5. The testing apparatus of claim 2, wherein the malocclusion test feature includes at least one region of crowded teeth.

6. The testing apparatus of claim 1, wherein the arch model includes at least one non-anatomical test feature.

7. The testing apparatus of claim 1, wherein the arch model is removably coupled to the arch platform.

8. The testing apparatus of claim 1, wherein the platform drive assembly is coupled to the arch platform and configured to move the arch platform relative to the ejector platform and the seating platform.

9. The testing apparatus of claim 1, wherein the ejector platform and the seating platform are separated by a fixed distance.

10. The testing apparatus of claim 1, further comprising one or more platform guides coupled to one or more of the ejector platform, the seating platform, and the arch platform.

11. The testing apparatus of claim 1, wherein the ejector platform comprises at least one ejector element positioned to extend through at least one opening in the arch model to eject the aligner from the arch model when the arch model is moved toward an ejected position.

12. The testing apparatus of claim 1, wherein the arch platform comprises a capture frame positioned to restrict movement of the aligner after the arch model is moved into an ejected position and the aligner is ejected from the arch model.

13. The testing apparatus of claim 1, wherein the seating platform comprises at least one seating driver positioned to engage the aligner to seat the aligner onto the arch model when the arch model is moved toward a seated position.

14. The testing apparatus of any claim 1, wherein the seating platform comprises an anterior guide positioned to engage an anterior portion of the aligner to guide the aligner toward alignment with the arch model when the arch model is moved toward a seated position.

15. The testing apparatus of claim 1, wherein the seating platform comprises a lateral guide positioned to engage a lateral surface of the aligner to guide the aligner toward alignment with the arch model when the arch model is moved toward a seated position.

16. The testing apparatus of claim 1, wherein the platform drive assembly comprises a powered motor.

17. The testing apparatus of claim 1, wherein the platform drive assembly comprises a manual user interface to power relative movement of the arch platform to the ejector platform and the seating platform.

18. A testing method for an aligner, comprising:
seating an aligner onto the arch model of the testing apparatus of claim 1,
operating the testing apparatus to perform one or more testing cycles on the aligner; and determining whether the aligner has failed after the one or more testing cycles.

19. The testing method of claim 18, further comprising conditioning the aligner prior to seating the aligner.
